(19) United States
(12) Patent Application Publication
(10) Pub. No.: US 2011/0171552 A1
(43) Pub. Date: Jul. 14, 2011

(54) AIR-COOLED FUEL CELL STRUCTURE WITH AIR-GUIDING ELEMENT

(75) Inventors: Feng-Chang Chen, Kwei Shan Township (TW); Wen-Hsin Chiu, Kwei Shan Township (TW); Chi-Bin Wu, Kwei Shan Township (TW)

(73) Assignee: Chung-Hsin Electric and Machinery Manufacturing Corp., Jhonghe City (TW)

(21) Appl. No.: 12/706,776

(22) Filed: Feb. 17, 2010

(30) Foreign Application Priority Data
Jan. 8, 2010 (TW) 099100313

(51) Int. Cl. H01M 2/00

(52) U.S. Cl. 429/439

(57) ABSTRACT

An air-cooled fuel cell structure with an air-guiding element is provided. The air-cooled fuel cell structure includes a fuel cell module, a fan cover, an electric fan, and the air-guiding element. The fan cover has a first opening and a second opening. The first opening of the fan cover is hermetically coupled to a first end portion of the gas flow channels of the fuel cell module. The electronic fan is disposed above the second opening of the fan cover. The air-guiding element is disposed in the fan cover. The air-guiding element guides gas flow in the fan cover to ensure uniform distribution of the gas flow in the gas flow channels of the fuel cell module. Thus, the temperature difference inside the fuel cell module can be reduced and the efficacy of the fuel cell module can be raised.

### BACKGROUND OF THE INVENTION

1. Technical Field

The present invention relates to an air-cooled fuel cell structure each with an air-guiding element, and more particularly, to an air-cooled fuel cell structure provided with an air-guiding element and configured for use with a fuel cell.

2. Description of Related Art

A fuel cell module is a power generating device to which fuel gas and air are fed before undergoing a series of electrochemical reactions to thereby turn chemical energy into electrical energy and produce electric current and water. A fuel cell module generates high electric power but causes minimal harm to the human body and environment and thus is one of the existing energy sources with the greatest potential in development.

However, the feeding of fuel gas and air and discharge of high-energy steam are important factors in the energy conversion rate of the fuel cell module. Also, it is important to feed fuel gas and air as well as discharge steam smoothly and evenly and maintain uniform distribution of gas/air flow inside the fuel cell module.

A fuel cell module 10 comprises a plurality of fuel cell bodies stacked up, as shown in FIG. 1. According to the prior art, a gas discharging or gas feeding system for use with the fuel cell module 10 is equipped with an electric fan 20 for directly removing gas therefrom or introducing gas thereto. As shown in FIG. 2, the central region of the fuel cell module 10 corresponds in position to the electric fan 20, and thus circulation of gas in the central region of the fuel cell module 10 is relatively smooth; hence, the central region of the fuel cell module 10 is of relatively low temperature. By contrast, the two lateral regions of the fuel cell module 10 do not correspond in position to the electric fan 20 and thus are of relatively high temperature. Therefore, distribution of temperature of the fuel cell module 10 is so uneven as to affect the efficacy of power generation in the lateral regions of the fuel cell module 10.

The prior art prevents the aforesaid uneven distribution of gas flow by increasing the length of a fan cover 30 and tapering the fan cover 30. In so doing, the uniformity of gas flow distribution inside the fuel cell module 10 improves, but the fan cover 30 then becomes bulky, expensive, and heavy, which precludes any further changes that can be made to the length of the fan cover 30. Accordingly, any improvement in the distribution of the circulating gas is limited.

### BRIEF SUMMARY OF THE INVENTION

The present invention relates to an air-cooled fuel cell structure with an air-guiding element and configured to control the direction in which the gas in a fuel cell module flows using the air-guiding element, so as to ensure uniform distribution of the gas flow inside the fuel cell module, decrease the temperature difference inside the fuel cell module, and enhance the efficacy of the fuel cell module in generating electric power.

The present invention relates to an air-cooled fuel cell structure with an air-guiding element and configured to ensure uniform distribution of the gas in the fuel cell module using the air-guiding element and decrease the length of a fan cover so as to reduce loss of pressure and electric fan power consumption and reduce the manufacturing cost and weight of the fan cover.

To achieve the above and other objectives, the present invention provides an air-cooled fuel cell structure with an air-guiding element comprising: a fuel cell module having a plurality of gas flow channels; a fan cover having a first opening and a second opening, the first opening being hermetically coupled to a first end portion of the gas flow channels; an electric fan disposed above the second opening; and the air-guiding element disposed in the fan cover for guiding gas flow inside the fan cover so as to ensure uniform distribution of the gas flow inside the gas flow channels.

In the air-cooled fuel cell structure with an air-guiding element, the fan cover is of a depth between 120 and 150 mm.

In the air-cooled fuel cell structure with an air-guiding element, the fan cover has an arciform inner wall.

In the air-cooled fuel cell structure with an air-guiding element, the air-guiding element is connected to the inner wall of the fan cover via a connector.

In the air-cooled fuel cell structure with an air-guiding element, the air-guiding element is positioned proximate to the first opening or the second opening.

In the air-cooled fuel cell structure with an air-guiding element, the air-guiding element is a polygonal air-guiding element, a round air-guiding element, or an elliptical air-guiding element.

Implementation of the present invention at least involves the following inventive steps:

1. Using the air-guiding element for ensuring the uniform distribution of gas flow in the fuel cell module, so as to reduce temperature difference inside the fuel cell module and enhance efficacy of the fuel cell module; and

2. Decreasing the length of the fan cover so as to enhance the performance of the electric fan, cut the manufacturing cost of the fan cover, reduce the weight of the fan cover, and minimize pressure loss.

The features and advantages of present invention are described in detail hereunder to enable persons skilled in the art to understand and implement the disclosure of the present invention and readily apprehend objectives and advantages of the present invention with references made to the disclosure contained in the specification, the claims, and accompanying drawings.

### BRIEF DESCRIPTION OF THE SEVERAL VIEWS OF THE DRAWINGS

FIG. 1 is a schematic view of the framework of a conventional fuel cell module with a long fan cover;

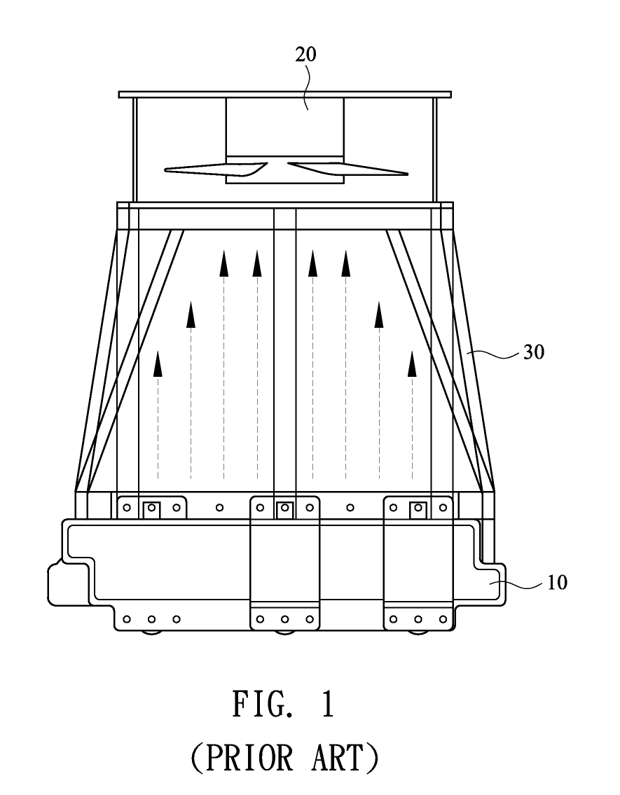

FIG. 2 is a diagram of distribution of temperature of the conventional fuel cell module with a long fan cover;

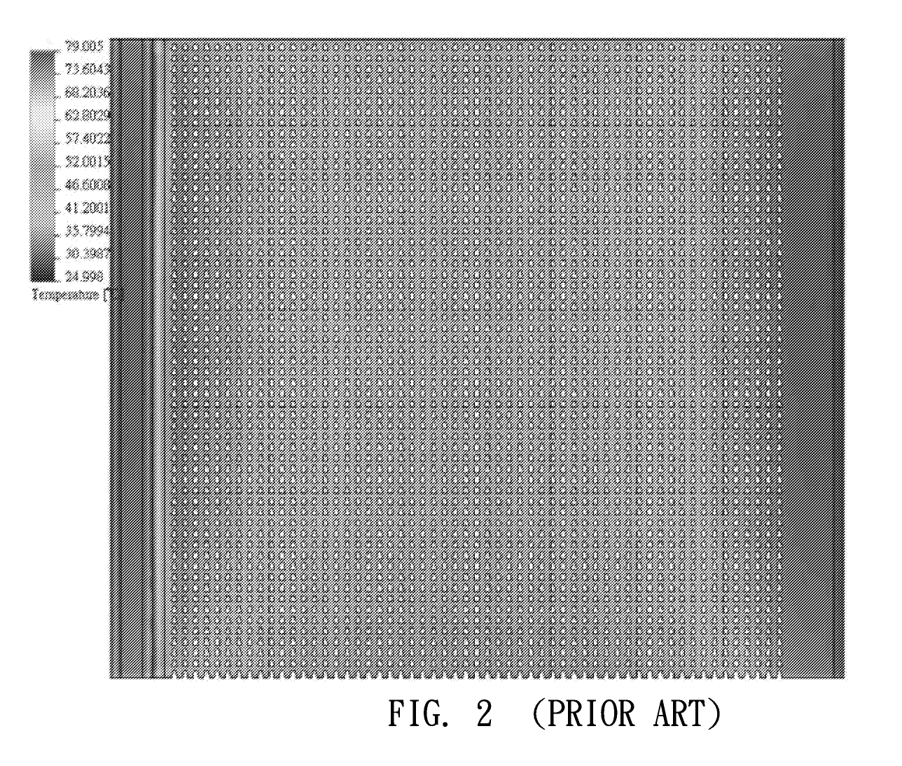

FIG. 3 is an exploded perspective view of an air-cooled fuel cell structure with an air-guiding element according to the present invention;

FIG. 4A is a schematic view of an embodiment of the air-guiding element connected to a fan cover via a connector according to the present invention;

FIG. 4B is a schematic view of another embodiment of the air-guiding element connected to the fan cover according to the present invention;

FIG. 5A is a schematic view of an embodiment of directions of gas flow inside the air-cooled fuel cell structure with the air-guiding element according to the present invention;

FIG. 5B is a schematic view of another embodiment of directions of gas flow inside the air-cooled fuel cell structure with the air-guiding element according to the present invention;

FIG. 6 is a diagram of distribution of temperature of an air-cooled fuel cell structure with a short fan cover but without an air-guiding element according to the present invention; and

FIG. 7 is a diagram of distribution of temperature of an air-cooled fuel cell structure with a short fan cover and an air-guiding element according to the present invention.

### DETAILED DESCRIPTION OF THE INVENTION

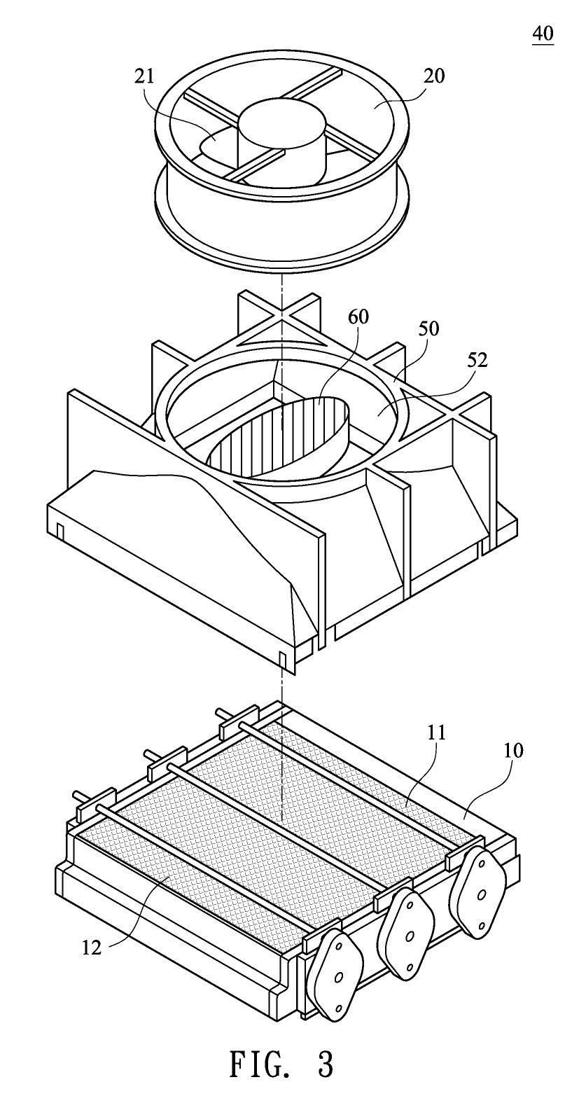

Referring to FIG. 3, in this embodiment, an air-cooled fuel cell structure 40 with an air-guiding element 60 comprises a fuel cell module 10, a fan cover 50, an electric fan 20, and an air-guiding element 60.

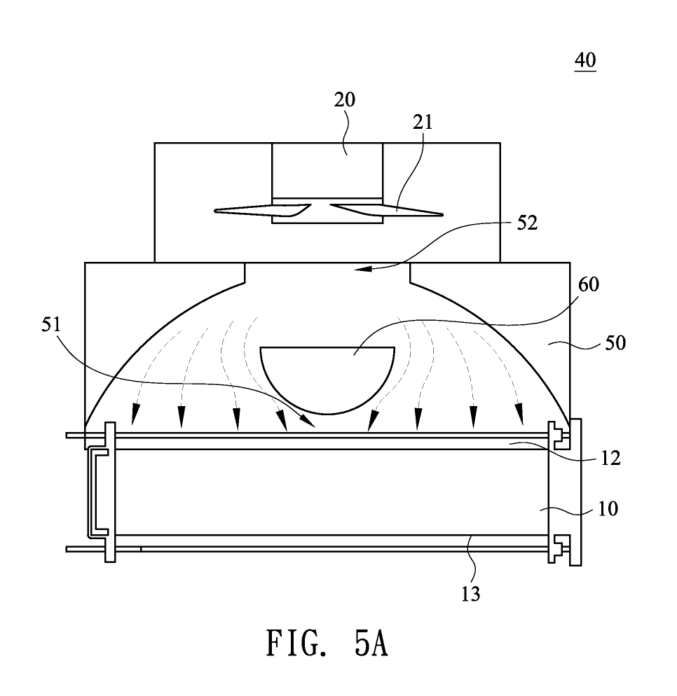

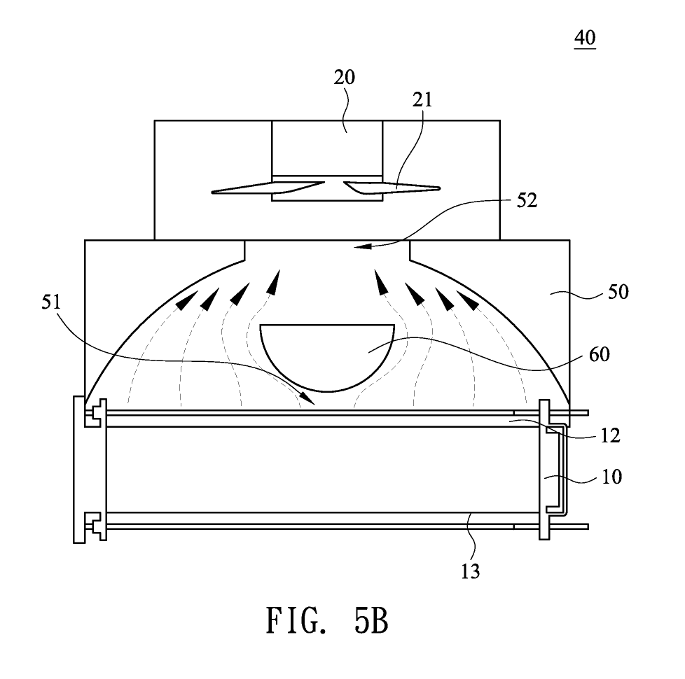

The fuel cell module 10 comprises a plurality of fuel cell bodies stacked up. The fuel cell module 10 has a plurality of gas flow channels 11 for feeding or discharging gas. The gas flow channels 11 has a first end portion 12 functioning as a gas feeding end portion and an opposing second end portion 13 (as shown in FIG. 5A) functioning as a gas discharging end portion. Alternatively, the first end portion 12 and the second end portion 13 of the gas flow channels 11 function as a gas discharging end and a gas feeding end, respectively (as shown in FIG. 5B).

The fan cover 50 has a first opening 51 (as shown in FIG. 5A) and a second opening 52. The fan cover 50 has a depth between 120 and 150 mm and thereby is considered a short fan cover when being compared with a conventional fan cover. The fan cover 50 has an arciform inner wall for facilitating gas flow. The first opening 51 is hermetically coupled to the first end portion 12 of the gas flow channels 11 of the fuel cell module 10.

The electric fan 20 is disposed above the second opening 52 and configured for rotation at a specific rotational speed. The electric fan 20 is provided with a plurality of blades 21 whereby gas is introduced into or drawn out of the fuel cell module 10.

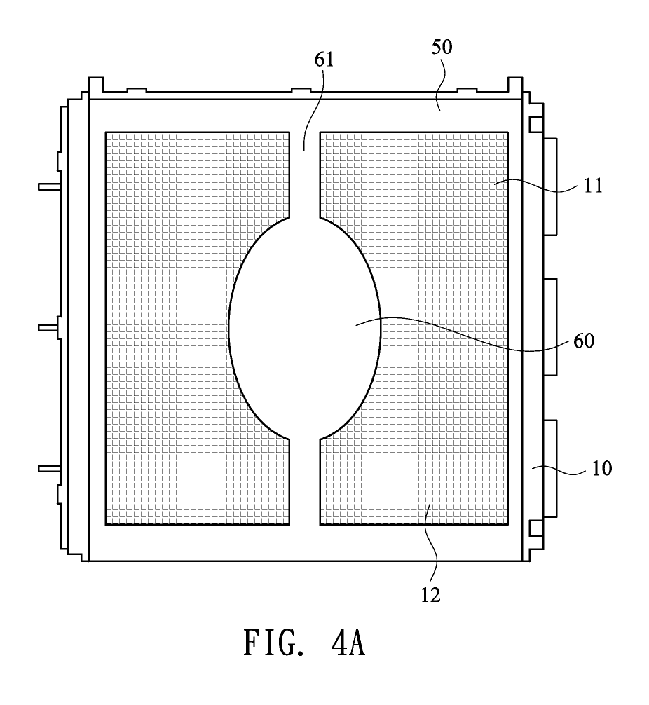

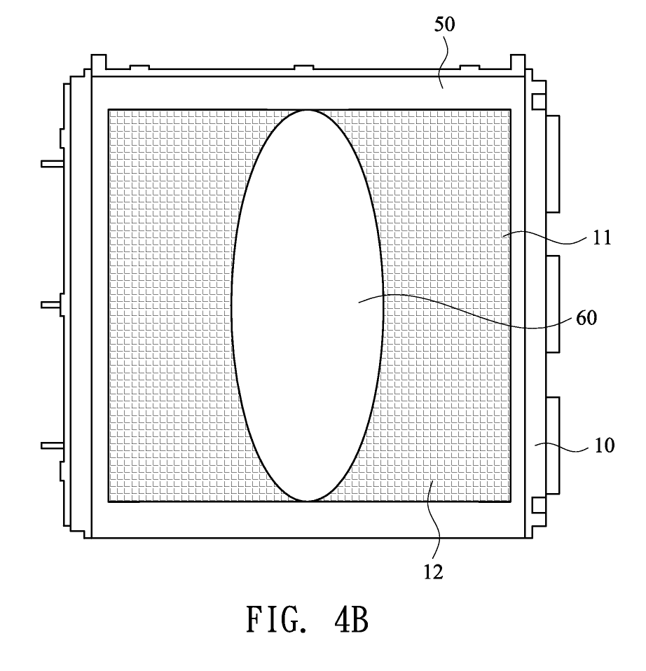

The air-guiding element 60 is disposed in the fan cover 50 for guiding gas flow inside the fan cover 50 so as to ensure uniform distribution of the gas flow inside the gas flow channels 11 of the fuel cell module 10. The air-guiding element 60 is a polygonal air-guiding element, a round air-guiding element, or an elliptical air-guiding element. The air-guiding element 60 is positioned proximate to the first opening 51 or the second opening 52 of the fan cover 50 but is not limited thereto. As shown in FIG. 4A, the air-guiding element 60 is connected to the inner wall of the fan cover 50 via a connector 61. Alternatively, as shown in FIG. 4B, the air-guiding element 60 is directly connected to the inner wall of the fan cover 50.

Referring to FIG. 5A, where the first end portion 12 is the gas feeding end, the electric fan 20 blows gas into the fuel cell module 10. With the air-guiding element 60 being positioned in the fan cover 50, gas inside the fan cover 50 reaches the fuel cell module 10 simultaneously, regardless of whether the gas travels centrally or laterally. Referring to FIG. 5B, where the first end portion 12 is the gas discharging end, the electric fan 20 draws gas out of the fuel cell module 10. With the air-guiding element 60 being positioned in the fan cover 50, gas inside the fan cover 50 is discharged from the fuel cell module 10 simultaneously by the air-guiding element 60, regardless of whether the gas travels centrally or laterally. Arrows shown in FIG. 5A and FIG. 5B indicate the direction of gas flow.

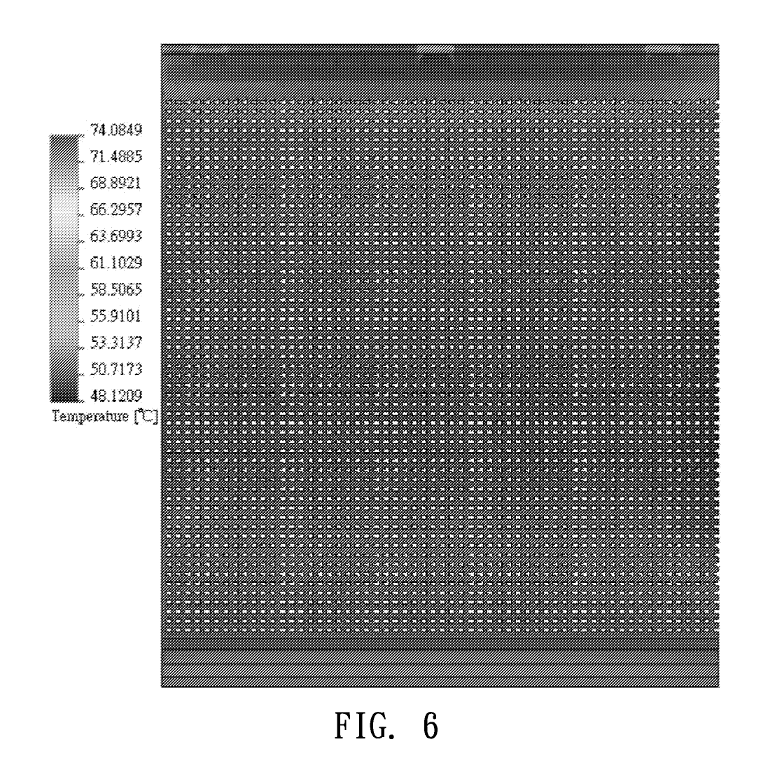

FIG. 6 depicts a diagram of temperature distribution of the air-cooled fuel cell structure 40 without the air-guiding element 60, so as to illustrate the necessity and functionality of the air-guiding element 60. As shown in FIG. 6, decreasing the length of a fan cover reduces pressure loss arising from internal gas circulation and reduces overall temperature, but fails to enhance uniformity of distribution of internal gas flow. Hence, it is proved that shortening the fan cover 50 or changing the design of the fan cover 50 merely reduces overall temperature, but fails to enhance uniformity of distribution of internal gas flow. Still, the fuel cell module 10 is internally subjected to a temperature difference.

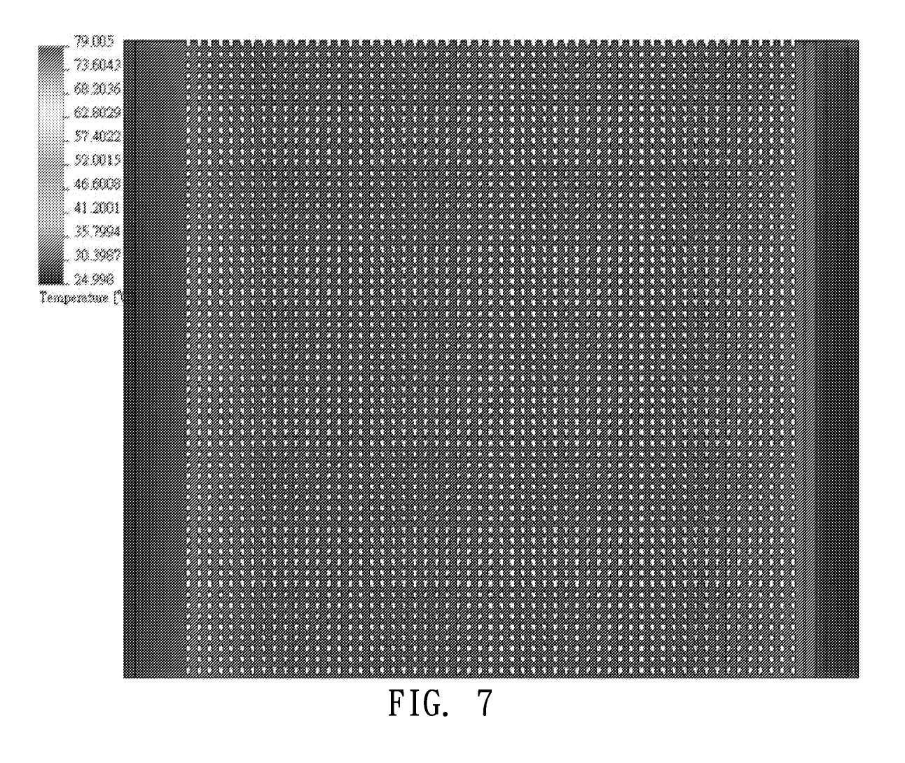

FIG. 7 depicts a diagram of temperature distribution of the air-cooled fuel cell structure 40 with the air-guiding element 60. As shown in the drawing, there is uniform distribution of temperature of the air-cooled fuel cell structure 40 with the air-guiding element 60. In this embodiment, the range of the temperature difference of the air-cooled fuel cell structure 40 with the air-guiding element 60 is preferably reduced to less than 5° C.

The foregoing embodiments are provided to illustrate and disclose the technical features of the present invention so as to enable persons skilled in the art to understand the disclosure of the present invention and implement the present invention accordingly, and are not intended to be restrictive of the scope of the present invention. Hence, all equivalent modifications and variations made to the foregoing embodiments without departing from the spirit and principles in the disclosure of the present invention should fall within the scope of the invention as set forth in the appended claims.

What is claimed is:

1. An air-cooled fuel cell structure with an air-guiding element, the air-cooled fuel cell structure comprising:
a fuel cell module having a plurality of gas flow channels;
a fan cover having a first opening and a second opening, the first opening being hermetically coupled to a first end portion of the gas flow channels;
an electric fan disposed above the second opening; and
the air-guiding element disposed in the fan cover for guiding gas flow inside the fan cover so as to ensure uniform distribution of the gas flow inside the gas flow channels.

2. The air-cooled fuel cell structure of claim 1, wherein the fan cover is of a depth between 120 and 150 mm.

3. The air-cooled fuel cell structure of claim 1, wherein the fan cover has an arciform inner wall.

4. The air-cooled fuel cell structure of claim 1, wherein the air-guiding element is connected to the inner wall of the fan cover via a connector.

5. The air-cooled fuel cell structure of claim 1, wherein the air-guiding element is positioned proximate to the first opening.

6. The air-cooled fuel cell structure of claim 1, wherein the air-guiding element is positioned proximate to the second opening.

7. The air-cooled fuel cell structure of claim 1, wherein the air-guiding element is a polygonal air-guiding element, a round air-guiding element, or an elliptical air-guiding element.
